(19) United States
(12) Patent Application Publication
(10) Pub. No.: US 2024/0054452 A1
(43) Pub. Date: Feb. 15, 2024

(54) METHOD OF IN-STORE ORDER FULFILLMENT AND CUSTOMER NOTIFICATION

(71) Applicants: Allan MALCOMSON, Richmond (CA); Elizabeth MALCOMSON, Ottawa (CA)

(72) Inventors: Allan MALCOMSON, Richmond (CA); Elizabeth MALCOMSON, Ottawa (CA)

(21) Appl. No.: 18/267,349

(22) PCT Filed: Dec. 7, 2021
(86) PCT No.: PCT/CA2021/051750

§ 371 Date: Jun. 14, 2023

Related U.S. Application Data
(60) Provisional application No. 63/125,552, filed on Dec. 15, 2020.

(51) Int. Cl. G06Q 10/087

(52) U.S. Cl. CPC G06Q 10/087

(57) ABSTRACT

The invention provides a computer implemented method of in-store order fulfillment and customer notification. The method includes locating and retrieving a product from in-store inventory and notifying a customer that the product is ready for pickup and optionally providing the customer the location of pickup.

### FIELD OF THE INVENTION

The present invention relates to a method of order fulfillment. In particular, a system and method of in-store order fulfillment and customer notification.

### BACKGROUND OF THE INVENTION

In general, order fulfillment may refer to a complete process from point-of-sales inquiry to delivery of an item or product to a customer. This process may take time as it may require a number of tasks including, for example, locating the item in the store's inventory, requesting retrieval of the item, retrieving the item for the customer. While the order is being filled, the customer may wait at the pick-up location or return at various times to check if the item has been retrieved.

Customer experience may be improved by streamlining the order fulfillment process and providing order status notifications to the customer.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a computer implemented method of in-store order fulfillment and customer notification. In accordance with an aspect of the present invention, there is provided a computer implemented method of in-store order fulfillment, said method comprising: (a) receiving, by a computer server device, an order for a product; (b) determining, by said computer server device, in-store inventory of said product; if said product is in said in-store inventory, (c) determining, by said computer server device, location of said product in said in-store inventory; (d) sending, by said computer server device, a request for retrieval of said product; (e) receiving, by said computer server device, confirmation that said product has been retrieved; (e) sending, by said computer server device, a notification said product has been retrieved and location of said retrieved product; and (f) optionally sending, by said computer server device, a request for replacement inventory of said product; if said product is not in said in-store inventory, (c) sending, by said computer server device, a notification that said product is not in said in-store inventory; (d) optionally, by said computer server device, sending a request for inventory of said product. In some embodiments, the method further comprises the step of querying the customer to establishes if the customer wants to pick up the product immediately or in the future and advising a retrieval team of the same. In some embodiments, the method triggers an order out of stock items and optionally notifies the customer once the item arrives back in stock for personalized service.

### BRIEF DESCRIPTION OF THE DRAWINGS

These and other features of the invention will become more apparent in the following detailed description in which reference is made to the appended drawings.

FIG. 1 presents a portal to the various interfaces of an embodiment of the present invention.

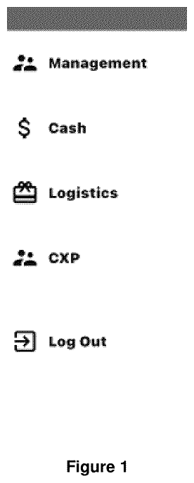

FIG. 2 presents the customer details interface of an embodiment of the present invention.

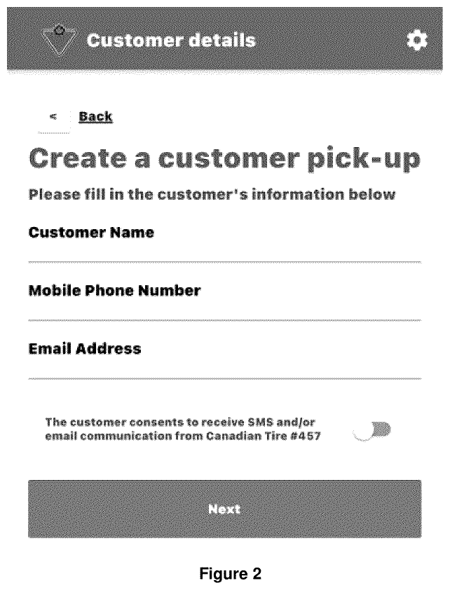

FIG. 3 presents the logistics interface of an embodiment of the present invention.

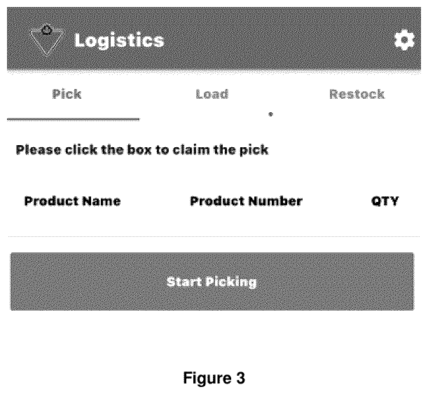

FIG. 4 presents the management interface of an embodiment of the present invention.

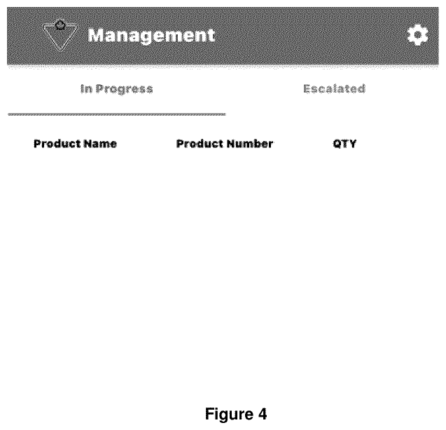

### DETAILED DESCRIPTION OF THE INVENTION

The present invention provides a system and method of order fulfillment and customer notification. In certain embodiments, the method relates to in-store order fulfillment and customer notification. The method allows customers to continue to shop or leave the establishment for a short period of time while a product is retrieved from inventory and notifies the customer when the product is ready for pick-up. This method may be particularly useful for large items that may be picked up from a pick-up location and/or items that are in a secure location in that customers are notified when the item is ready for pick-up. Optionally, the notification can include location of pick-up. Optionally, location may be shown on a map. In some embodiments, the method will retrieve customer location information and show routes to pick-up location.

The methods of the present invention comprise:

(a) Receiving, by a computer server device, an order for a product.

The present invention provides an interface to order one or more products for customer pick-up. The interface may be app based or web-based. The order may be placed directly by the customer or by a store employee. For example, in in-store embodiments, the customer may go to a customer service desk or cashier who then inputs the order using the interface on a computer device in communication with computer server device. In other in-store embodiments, self-help interfaces on a computer device (including but not limited to in-store kiosks) in communication with the computer server device. In certain embodiments the order includes customer information such as name and contact information (such as cellphone number and/or email address) and product information such as product name, product number and quantity ordered. Optionally, the order includes payment information such as customer credit card information.

Alternatively, the customer may order the product through the app. In such embodiments, the customer may optionally select a preferred or home store.

(b) Determining, by said computer server device, in-store inventory of said product.

In certain embodiments, the system of the present invention comprises or is in communication with a database of in-store inventory. The database of in-store inventory may be part of an inventory management system. Accordingly, in certain embodiments, the system of the present invention may be a component of an inventory management system or is in communication with the inventory management system. The inventory database may be searched by one or more search terms including but not limited to product description, product name and product number.

If the product is in the in-store inventory, the method comprises:

The location(s) of unit(s) of the product is determined. In certain embodiments, the location(s) and quantity of units of the product is in the inventory database.

A request for retrieval of the product is then sent. The request may include one or more of the following product identifier (such as product name and/or product number); number of units of product requested; location(s) of the product. The request may also include order identifier such as order number and/or customer information; delivery location such as customer service desk or cashier location, optional offsite delivery and/or assembly. The request may also include urgency of the request, for example, immediate retrieval required when customer is waiting. The request may be communicated to the party responsible for product retrieval by a number of means including but not limited to push notifications, email, text message including sms or im, in-program or in-app messaging, or voice (including automated voice messages). In certain embodiments, the request requires confirmation of retrieval request from the party responsible for product retrieval. In certain embodiments, if no confirmation is received within a predetermined amount of time, a further notification is sent to either the party responsible for product retrieval and/or another party, such as a manager. Optionally, the customer is also notified to indicate action being taken.

Optionally, the system automatically sends a notification to the device placing the order (i.e. customer service desk or cashier device) and/or customer's device that the request for retrieval has been sent. The notification may include an expected time for delivery of the product to pick-up location and/or a notification that the product is ready for pick-up. The notification may be by a number of means including but not limited to push notifications, email, text message including sms or im, in-program or in-app messaging, or voice (including automated voice messages).

Optionally, in some embodiments, when a product is located in inventory a status update is sent.

In embodiments where products may be inspected on retrieval from inventory, the notification that the product is ready for pick-up is only sent upon confirmation that the product has passed a pre-pick-up inspection. If the product fails the pre-pick-up inspection, the customer is optionally notified that the product is unavailable from in store inventory or that the product is available at a discounted price. The customer will be optionally automatically notified of change in order status and requested to either cancel order, order product from non-store inventory for pick-up at a later date or delivery or accept discounted price for damaged product. In embodiments, where products will be made available at a discounted price, the method and system may automatically request a manager to approve a discount. Accordingly, the method and system may provide a manager interface to modify sale price. In some embodiments, the method and system may be further configured to recommend alternative products if product is not available for pick-up or if product is damaged. Optionally, a tracking method is in place to protect against price manipulation for daily/weekly reviews. Optionally, the tracking method is restricted to manager use only.

Retrieval of the product is confirmed. In certain embodiments, the cashier or customer service representative input into the user interface that the products have been retrieved.

A notification is then sent (optionally automatically sent) to the customer that ordered the product. The notification may include an order identification (such as an order number or customer name) and/or location of where the product may be picked up. The notification may be by a number of means including but not limited to push notifications, email, text message including sms or im, in-program or in-app messaging, or voice (including automated voice messages). In certain embodiments, if the product is not picked up by the customer in the store within a predetermined amount of time, a further notification is sent to the customer or the product is sent for home delivery.

In certain embodiments, the inventory is updated following retrieval of the product and/or pick up by the customer. In certain embodiments, a request for restock inventory is sent following retrieval of the product and/or pick up by the customer. In certain embodiments, the system automatically orders inventory from suppliers when in-store inventory of the product is less than a predetermined amount.

If the product is not in the in-store inventory, the method comprises:

A notification that the product is not in the in-store inventory or an insufficient number of units of the product are in stock, is sent (optionally automatically sent) to the device placing the order (i.e. customer service desk or cashier device) and/or customer's device. The notification may be by a number of means including but not limited to push notifications, email, text message including sms or im, in-program or in-app messaging, or voice (including automated voice messages).

In certain embodiments, the notification includes an option to request that the order be partially filled and/or an alternative in-stock product suggestion. In such embodiments, optionally, if the customer requests a partial order and/or alternative in-stock product, a request for retrieval is sent (optionally automatically sent). If the order is partially filled, the system sends (optionally automatically sends) a notification to the customer when remaining product is ready for pickup. In certain embodiments, if the order is partially filled, the customer is provided the option for home delivery of the remaining product.

In certain embodiments, an option to order the product is provided to the customer. In such embodiments, delivery options such as in-store or home delivery is optionally provided.

In certain embodiments, if the product is not available, the system automatically issues the customer a raincheck for the product.

In certain embodiments, a request for restock inventory is sent. In certain embodiments, the system automatically orders inventory from suppliers.

In some embodiments, customer orders do not move from one section to the next until it is complete thereby minimizing loss prevention issues and enhancing security.

In certain embodiments, during the loading process, the receipt is logged and an image of the product is uploaded for future follow up and security, Optionally, an order cannot be closed without completing this step.

In certain embodiments, the system allows for reporting. Reporting may include for example, how many orders completed, order status of pending orders, orders not completed etc. Reporting may be scheduled, such as daily, weekly, biweekly, monthly and/or upon request. Other information that may be reported includes time required to complete order, customer wait time may also be collected.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

We claim:

1. A computer implemented method of in-store order fulfillment, said method comprising:
(a) receiving, by a computer server device, an order for a product;
(b) determining, by said computer server device, in-store inventory of said product;
if said product is in said in-store inventory,
(c) determining, by said computer server device, location of said product in said in-store inventory
(d) sending, by said computer server device, a request for retrieval of said product;
(e) receiving, by said computer server device, confirmation that said product has been retrieved;
(e) sending, by said computer server device, a notification said product has been retrieved and location of said retrieved product; and Claims
(f) optionally sending, by said computer server device, a request for replacement inventory of said product;
if said product is not in said in-store inventory,
(c) sending, by said computer server device, a notification that said product is not in said in-store inventory;
(d) optionally, by said computer server device, sending a request for inventory of said product.
